(19) United States
(12) Patent Application Publication
(10) Pub. No.: US 2003/0116267 A1
(43) Pub. Date: Jun. 26, 2003

(54) Low-cost method of assembling structures with 3-D woven connectors

(76) Inventors: Patrick D. Sheahen, Fort Worth, TX (US); Ronald P. Schmidt, Fort Worth, TX (US)

Correspondence Address: James E. Bradley, BRACEWELL & PATTERSON, LLP, Suite 2900, 711 Louisiana Street, Houston, TX, 77002-2781, US

(21) Appl. No.: 10/028,613

(22) Filed: Dec. 21, 2001

(51) Int. Cl. B32B 31/00

(52) U.S. Cl. 156/293; 156/307.1

(57) ABSTRACT

A method uses a three-dimensional, woven preform to assemble two components, the preform having at least a pair of legs extending from a base. The woven preform is infused with a resin, and at least one surface of one of the components is bonded to the legs of the preform using the resin within the preform. The other of the components is then attached to the preform by adhering the component with the resin in the preform. The preform is squeegeed into place, ensuring that air pockets are eliminated and a continuous bond line is created. Resin systems providing for oven or room-temperature curing may be used.

### BACKGROUND OF THE INVENTION

1. Field of the Invention

This invention generally relates to assembly of components using woven preforms and particularly relates to low-cost assembly of components using resin-infused preforms.

2. Description of the Prior Art

FIGS. 1 through 3 show typical structures formed with methods known in the art for connecting two components and using layers of composite fabric. FIG. 1 shows a T-shaped structure 11 formed by attaching planar, metal component 13 to planar, composite component 15, with components 13, 15 being oriented to be perpendicular to each other and component 13 being located within the length of component 15. Several layers 17 of woven fabric are laid at the intersection of components 13, 15, a portion of a base layer 17 being applied to each of surfaces 19, 21 of component 13, the remaining portion of each base layer 17 being applied to surface 23 of component 15. Layers 17 may be pre-impregnated with resin, or resin may be applied onto layers 17 after laying them. Additional layers 17 are then applied over the base layers 17, layers 17 forming L-shaped supports. Layers 17 are cured to form structure 11, layers 17 typically being cured with heat and under vacuum. Though shown as connecting a metal component 13 to a composite component 15, layers 17 can be used to connect components 13, 15 formed from various materials. Also, one or both of components 13, 15 may be formed to have a curved shape.

In FIG. 2, components 13, 15 are attached to be perpendicular to each other, but component 13 is attached at one end of component 15. Several layers 17 are laid on the inside of the intersection of components 13, 15, with a portion of the base layer 17 being attached to surface 19 of component 13 and the remaining portion being attached to surface 23 of component 15. Likewise, a base layer 17 is laid on the outside of the intersection, with a portion of the base layer 17 being attached to surface 21 of component 13 and the remaining portion being attached to surface 25 of component 15. Additional layers 17 are applied over each base layer 17, and layers 17 are cured to form structure 27.

Structure 29, shown in FIG. 3, is formed by connecting components 13, 15 to lie in the same plane. Base layers 17 connect surface 19 of component 13 to surface 23 of component 15 and connect surface 21 of component 13 to surface 25 of component 15. Additional layers 17 are then laid over base layers 17, and layers 17 are cured.

The joints created using the prior art methods have difficulty withstanding out-of-plane loading. Typical remedies for this are thick laminate stack-ups using many layers of-composite fabric and having large flange radii. While this reduces the tensions forces between the layers of the flanged section, the result is a heavy joint, reducing the weight savings realized when using composites. Also, to obtain the greatest performance, these joints are cured using vacuum and heat, increasing the cost of the structures. Therefore, there is a need for a low-cost, simple method for creating high-strength joints which does not require vacuum or heat.

### SUMMARY OF THE INVENTION

A method uses a three-dimensional, woven preform to assemble two components, the preform having at least a pair of legs extending from a base. The woven preform is infused with a resin, and at least one surface of one of the components is bonded to the legs of the preform using the resin within the preform. The other of the components is then attached to the preform by adhering the component with the resin in the preform. The preform is squeegeed into place, ensuring that air pockets are eliminated and a continuous bond line is created. Resin systems providing for oven or room-temperature curing may be used.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a profile view of a structure formed by connecting two components with composite layers using a prior-art method.

FIG. 2 is a profile view of a second structure formed by connecting two components with composite layers using a prior-art method.

FIG. 3 is a profile view of a third structure formed by connecting two components with composite layers using a prior-art method.

FIG. 4 is a perspective view of a Pi-shaped woven preform for use in the method of the present invention.

FIG. 5 is a profile view of a structure formed by connecting two components with a woven preform using the method of the present invention.

FIG. 6 is a perspective view of an H-shaped woven preform for use in the method of the present invention.

FIG. 7 is a profile view of a second structure formed by connecting two components using the preform of FIG. 6 and the method of the present invention.

FIG. 8 is a profile view of a third structure formed by connecting two components using the preform of FIG. 6 and the method of the present invention.

### DETAILED DESCRIPTION OF THE INVENTION

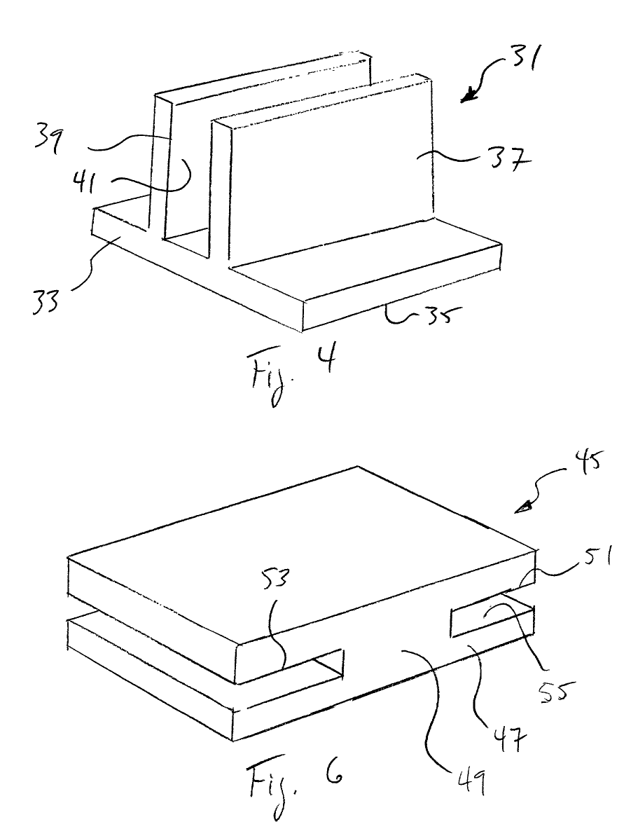

The present invention is directed toward a low-cost, simple method of using multi-layered, three-dimensional (3-D), woven preforms to connect components in a structure. These structures will typically be used in applications in which high strength is required but weight is not as critical, for example, in tooling or in boats. FIGS. 4 and 6 show examples of 3-D preforms, whereas FIGS. 5, 7, and 8 show the application of these preforms.

Referring to the figures, FIG. 4 shows api-shaped, 3-D, multi-layered, woven preform 31 used to connect two components, which may be formed to be planar or curved and of various materials, such as metal or composites. Preform 31 has a base 33 on its lower portion that has a continuous, flat lower surface 35. A pair of spaced-apart planar legs 37 extend vertically upward from base 33, forming a slot 39. Each leg 37 is at a position that is offset from, but near to, the center of base 33. Legs 37 are shown as parallel to each other and perpendicular to base 33, though legs 37 could be at angles to each other and to base 33. Legs 37 maybe oriented to be farther apart at the tops of legs 37, forming a “V” shape. Likewise, legs 37 may be oriented so that the bottoms of legs 37 are farther apart than the tops, forming a trapezoidal shape. In the position shown, inner surfaces 41 of legs 37 face each other for receiving a component. Though it is preferable for the outer surface of legs 37 and the upper surface of base 33 to be tapered at their outer ends, the ends may also be squared, as shown.

Preform 31 may be pre-impregnated with resin prior to assembly or may be dry. In the preferred method, preform 31 is prepregged with a heat-cured resin available from Cytec Industries, Inc., of West Paterson, N.J., under the trademark ONS. This resin system has a high viscosity and provides for a high-tack surface, allowing surfaces 35, 41 to stick to surfaces of components during assembly.

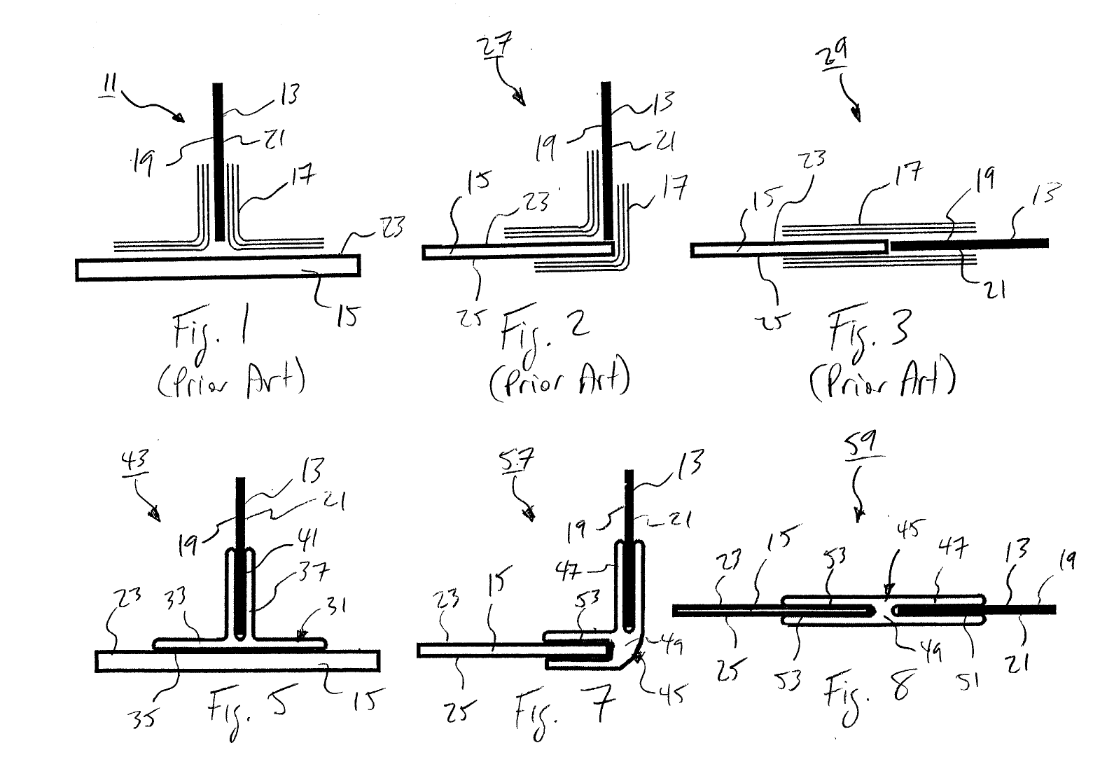

Referring to FIG. 5, structure 43 comprises components 13,15 connected in the same orientation as structure 11 (FIG. 1). Surfaces 19, 21 of component 13 are bonded to inner surfaces 41 of legs 37, and lower surface 35 of preform 31 is bonded to upper surface 23 of component 15. As shown, component 13 is perpendicular to component 15, though this is not required.

To form structure 43 using a prepreg preform 31, component 13 is placed between legs 37, surfaces 19, 21 adhering to surfaces 41, and surface 35 of base 33 is adhered to upper surface 23 of component 15. Legs 37 and base 33 are then squeegeed or otherwise pressed against components 13, 15 to eliminate air pockets and to form continuous bondlines. The resin is then cured in an oven, bonding components 13, 15 to preform 31.

During curing of the resin in preform 31, no vacuum bagging is necessary. Without vacuum bagging, the excess resin in preform 31 is not removed, yet structure 43 has a higher strength per weight than a joint made using the prior-art methods. Also, preform 31 has rough outer surfaces. When used in tooling or similar applications, the weight of the extra resin and the rough exterior do not significantly affect the use of structure 43. However, the fabrication time and costs are greatly reduced when compared to the prior-art methods.

To form structure 43 using a dry preform 31, a two-part resin system that cures at room temperature is preferably used. Resin is applied to the lower, bonding portions of surfaces 19, 21 of component 13 and to the bonding portion of upper surface 23 of component 15. Component 13 is then placed between inner surfaces 41 of legs 37, and lower surface 35 of preform 31 is placed against upper surface 23 of component 15 in the desired position. Alternatively, preform 31 can be positioned on components 13, 15 prior to application of resin, then legs 31 and base 33 can be pulled back to apply resin to surfaces 19, 21, 23 of components 13, 15. Additional resin is applied to the outer surfaces of preform 31, wetting the fibers of preform 31 and ensuring a sufficient amount of resin to form a continuous bondline between surfaces 41 and surface 19, 21 and between surface 35 and surface 23. A vacuum assist can optionally be used to ensure complete wet-out. Legs 37 and base 33 are squeegeed onto components 13, 15, respectively, to remove air pockets, then the resin in preform 31 is allowed to cure at room temperature. Though the need for heating is eliminated, heat may optionally be used during curing.

FIG. 6 shows an H-shaped, 3-D, woven preform 45 used to connect components as in structure 27 (FIG. 2) and structure 29 (FIG. 3). Preform 45 comprises two sets of spaced-apart legs 47, legs 47 extending from a central base section 49 to form slots 51, 53. Inner surfaces 55 of legs 47 face each other for receiving a component in slots 51, 53. Legs 47 within each set are shown as parallel, though legs 47 may also be at angles to each other. Also, the sets of legs 47 are shown to be parallel, though preform 45 may be formed or positioned so that the sets of legs 47 are at an angle relative to each other. Preform 45 may be pre-impregnated with resin, or may be used dry using the same method of assembly as described above.

FIGS. 7 and 8 show preform 45 being used to connect components 13, 15 in structures 55, 57, respectively. Component 13 is adhered to surfaces 55 in slot 51, and component 15 is adhered to surfaces 55 within slot 53. In structure 57, components 13, 15 are oriented to be perpendicular to each other, whereas components 13, 15 are parallel in structure 59.

To assemble structures 57, 59, a prepreg preform 45 is preferably used. Component 13 is placed between legs 47 of slot 51, and surfaces 55 are placed against surfaces 19, 21. Component 1 is placed within slot 53, and surfaces 55 are placed against surfaces 23, 25. Legs 47 are then oriented at the desired angle relative to each other to form structure 57 or 59, and legs 47 are squeegeed onto components 13, 15 to form consistent bondlines before curing in an oven.

When using a dry preform 45, a two-part resin is applied to an end portion of surfaces 19,21 of component 13, and component 13 is placed within slot 51, surfaces 55 being placed against component 13. Resin is also applied to an end portion of surfaces 23, 25 of component 15, which is then placed within slot 53. As described above, preform 45 may be assembled with components 13, 15 before application of resin, wherein legs 47 are pulled back to allow for resin to be applied to surfaces 19, 21, 23, 25. Additional resin is applied to the outer surfaces of preform 45, and legs 47 are squeegeed onto components 13, 15. Components 13, 15 are positioned in their desired angular orientation, and the resin is allowed to cure at room temperature.

The advantages of the present invention include the increased strength from using an a 3-D woven preform to connect components, while providing a low-cost, simple method of use. The present method avoids the thick, heavy stack of layers used in the prior art methods, and heat during curing is not required when using a resin system that cures at room temperature. Thus, fabrication time and costs are reduced.

While the invention has been shown in only some of its forms, it is not thus limited but is susceptible to various changes and modifications without departing from the spirit thereof. For example, a cross-shaped preform may be used, or the preform may have more than two legs extending from the base.

I claim:

1. A method for bonding a first component to a second component, the method comprising:
(a) providing a multi-layered, three-dimensional preform of woven fabric having a base portion and at least one pair of legs extending therefrom, defining a slot between the legs;
(b) infusing the preform with a resin;
(c) inserting at least one surface of the first component into the slot and adhering the legs of the preform to the first component using the resin;
(d) adhering the base portion of the preform to at least one surface of the second component using the resin; and then
(e) curing the resin without maintaining compaction pressure on the preform.

2. The method of claim 1, wherein:
step (d) comprises orienting the second component to be generally perpendicular to the first component after attachment.

3. The method of claim 1, wherein:
step (c) comprises squeegeeing the legs of the preform to the first component; and
step (d) comprises squeegeeing the base portion of the preform to the second component.

4. The method of claim 1, wherein:
step (a) further comprises providing the preform with a second pair of legs extending from the base portion, defining a second slot between the second pair of legs; and
step (d) comprises inserting the at least one surface of the second component into the second slot.

5. The method of claim 4, wherein:
step (c) comprises squeegeeing the legs of the preform to the first component; and
step (d) comprises squeegeeing the second pair of legs to the second component.

6. The method of claim 1, wherein:
step (a) further comprises providing the preform with a second pair of legs extending from the base portion, defining a second slot between the second pair of legs; and
step (d) comprises inserting the at least one surface of the second component into the second slot, the second component being generally parallel to the first component.

7. The method of claim 1, wherein:
step (a) further comprises providing the preform with a second pair of legs extending from the base portion, defining a second slot between the second pair of legs; and
step (d) comprises inserting the at least one surface of the second component into the second slot, the second component being generally perpendicular to the first component.

8. The method of claim 1, wherein:
step (e) comprises curing the resin at room temperature.

9. The method of claim 1, wherein:
step (e) comprises curing the resin at a temperature higher than room temperature.

10. The method of claim 1, wherein:
step (a) comprises providing a resin-free preform;
steps (c) and (d) comprise applying an amount of resin to portions of the components prior to adhering the legs and the base portion to the components; and
step (b) comprises applying an additional amount of resin on the preform after steps (c) and (d).

11. A method for bonding a first component to a second component, the method comprising:
(a) providing a multi-layered, three-dimensional preform of woven fabric having abase portion and at least two pairs of legs extending therefrom, defining a first slot between one of the pairs of legs and a second slot between the other of the pairs of legs;
(b) infusing the preform with a resin;
(c) inserting at least one surface of the first component into the first slot and adhering the legs defining the first slot to the first component using the resin;
(d) inserting at least one surface of the second component into the second slot and adhering the legs defining the second slot to the second component using the resin; and then
(e) curing the resin without maintaining compaction pressure on the preform.

12. The method of claim 11, wherein:
step (d) comprises orienting the second component to be generally perpendicular to the first component.

13. The method of claim 11, wherein:
step (d) comprises orienting the second component to be generally parallel to the first component.

14. The method of claim 11, wherein:
step (a) comprises providing a resin-free preform;
steps (c) and (d) comprise applying an amount of resin to portions of the components prior to adhering the legs and the base portion to the components; and
step (b) comprises applying an additional amount of resin on the preform after steps (c) and (d).

15. The method of claim 11, wherein:
step (c) comprises squeegeeing the legs of the first slot to the first component; and
step (d) comprises squeegeeing the legs of the second slot to the second component.

16. A method for bonding a first component to a second component, the method comprising:
(a) providing a resin-free, multi-layered, three-dimensional preform of woven fabric having a base and at least one pair of legs extending therefrom, defining a slot between the legs;
(b) applying an amount of resin to at least one surface of the first component;
(c) applying an amount of resin to at least one surface of the second component;
(d) inserting the at least one surface of the first component into the slot and adhering the legs of the preform to the first component using the resin on the first component;
(e) adhering the base portion of the preform to the second component using the resin on the second component; then
(f) applying additional resin onto the preform to fully wet fibers of the preform; and then
(g) curing the resin without maintaining compaction pressure on the preform.

17. The method of claim 16, wherein:
step (e) comprises orienting the second component to be generally perpendicular to the first component after attachment.

18. The method of claim 16, wherein:
step (d) comprises squeegeeing the legs of the preform to the first component; and
step (e) comprises squeegeeing the base portion of the preform to the second component.

19. The method of claim 16, wherein:
the resin is a laminating resin that cures at room temperature.

20. The method of claim 16, wherein:
the resin is a laminating resin that cures at a temperature higher than room temperature.
